(19) United States
(12) Patent Application Publication
(10) Pub. No.: US 2012/0196997 A1
(43) Pub. Date: Aug. 2, 2012

(54) COMPOSITIONS OF GLYCIDYL METHACRYLATE COPOLYMER SUITABLE AS CHAIN EXTENDER FOR POLY(LACTIC ACID)

(75) Inventors: SZUPING LU, Canton, MI (US); Rahul Holla, Saline, MI (US); Benjamin Morley, Adrian, MI (US)

(73) Assignee: ANDERSON DEVELOPMENT COMPANY, Adrian, MI (US)

(21) Appl. No.: 13/359,168

(22) Filed: Jan. 26, 2012

Related U.S. Application Data
(60) Provisional application No. 61/437,207, filed on Jan. 28, 2011.

(51) Int. Cl. C08F 124/00

(52) U.S. Cl. 526/273

(57) ABSTRACT

Ranges of glycidyl methacrylate containing acrylic resin monomer compositions and polymer properties which are suitable to be used in chain extension processes for Poly(lactic acid) or Polylactide (PLA). The selection of monomer compositions and molecular weight ranges of the acrylic chain extender resins, and the examples of chain extension reaction between the acrylic chain extender and PLA are also provided.

### BACKGROUND

Although the polylactide (PLA) was first prepared by polycondensation in 1948 and the first ring-opening polymerization process to make PLA was developed by DuPont in 1954, but due to its cost, difficulty to manufacture at higher molecular weight, and difficulty to process the PLA polymer using standard process equipment, there was no large scale of PLA production until about year 2000. Motivated by the sustainability and biodegradability, many new process and applications for PLA have been developed in just recent few years.

Mitsui Chemical filed a Japanese patent application (JP 2000-273164) in 2000 directed to an azeotropic dehydration process to make PLA at a molecular weight of up to 30,000. Many approaches have been developed regarding attempts to improve the processing characteristics and properties of from PLA virgin polymer. Included among them are approaches to chemical chain extension and branching process using well known polymer chemical reaction. For example, using epoxided fat or oil as a PLA chain extender was described in WO 02/100921A1, using peroxide as a chain extender was described in U.S. Pat. No. 5,594,059 and U.S. Pat. No. 5,798,435, using isocyanates as a chain extender was described U.S. Pat. No. 5,346,966 and recently described in CAN 148:356624 AN 2007:433574. Among all known chemical chain extenders for PLA, epoxy functional compounds are the most studied in peer-reviewed papers and described in patent publications, such as U.S. Pat. No. 5,470,944, then in JP 2000-224868, JP 2004-319818, JP2005-029758, JP 2006-232975, WO 2006/101076, JP 2007-270391, US 2008/0050603, CN 2009-10103571, CN 2009-10054904, US 2009/0312500, and most recently CN 2010-10250346. Although not specified to be used in PLA chain extension, U.S. Pat. No. 6,984,694 describes ranges of epoxy-functional (meth)acrylic styrene copolymer to be used in processing of wide ranges of condensation polymers.

As described above, although the use of epoxy containing compounds for chain extension of general condensation polymers and PLA are well known. However, they are either not epoxy functional acrylic copolymers, or outside certain suitable molecular weight ranges, or not well defined polymer compositions to optimize the chain extension reaction specifically for PLA.

Basically, all the solid glycidyl methacrylate acrylic resins commonly used in powder coating industry as well as other epoxy functional compounds can naturally be used as chain extenders for PLA or other polycondensation polymers. However, their molecular weight, monomer compositions, and other resin designed properties typically do not give them fast chain extension rate in a PLA application. A fast chain extension rate for a PLA application is considered to be 20% increased Mw/hour, more preferably 25% increased Mw/hour measured by a method described in this invention.

### SUMMARY

In an embodiment, the disclosure provides a resin. Preferably, the resin is suitable for powder coating. Preferably, the resin is an epoxy functional acrylic resin prepared from a monomer composition comprising at least one epoxy functional monomer. More preferably, the monomer composition comprises glycidyl methacrylate or glycidyl acrylate, most preferably glycidyl methacrylate. The resin may have a chain extension capability with PLA resins at a rate of at least 20% increased Mw/hour, more preferably 24% increased Mw/hour, measured by a method described in this invention.

The resin may be prepared from a monomer composition comprising 15-60 wt % glycidyl methacrylate, 5-30 wt % of at least one an acrylate monomer having a Tg of less than (negative) −50° C. The remainder may comprise 10-80 wt % of at least one ethylenically unsaturated monomer, more preferably 25-75 wt % of at least one ethylenically unsaturated monomer. The at least one acrylate monomer is preferably selected from n-butyl acrylate or polycaprolactone acrylate. The monomer composition may comprise 20-50 wt % glycidyl methacrylate, more preferably 25-45 wt % glycidyl methacrylate. The monomer composition may comprise 5-25 wt % of the acrylate monomer, more preferably 7-20 wt % of the acrylate monomer.

The resin may have a number average molecular weight greater than 4000, more preferably greater than 5000, even more preferably greater than 5900, even more preferably greater than 6000, even greater than 6500, even greater than 7000, and even greater than 7300. The resin may have an epoxy equivalent weight (EEQ) in the range of 250 to 720, preferably 280 to 600, more preferably 320 to 570. The resin may have a melt index 5 to 100 g/10 minutes, preferably at 10 to 60 g/10 minutes.

The resin may be adapted to be used as chain extender in PLA thermal process applications. A PLA thermal process application is an application at 150° C. or higher.

The disclosure also provides embodiments of a resin in a particulate form. The resin may have a particle size distribution of less than 30% of the particles are 2-4 mm; 50-90% of the particles are 0.1-2 mm; and 3-25% of the particles are less than 0.1 mm. Preferably, the resin may have a particle size distribution of less than 20% of the particles are 2-4 mm; 70-80% of the particles are 0.1-2 mm; and 5-15% of the particles are less than 0.1 mm.

### BRIEF DESCRIPTION OF THE FIGURES

FIG. 1 illustrates a comparison of molecular weight change from the use of various types of epoxy functional acrylics by chain extension reaction

### DETAILED DESCRIPTION

As a result of assiduous study with a view to optimize the performance specifically in PLA chain extension applications, inventors of the present invention have unexpectedly discovered a resin comprising glycidyl methacrylate containing acrylics to provide fast chain extension reaction with PLA.

Without being bound to theory, one embodiment of the disclosure relates to the use of low Tg (<−50° C.) acrylate monomers, such as n-butyl acrylate and polycaprolactone acrylate, to design a solid epoxy containing acrylic resins which have suitable high number average molecular weight (Mn) and epoxy functionality to provide fast chain extension capability while not crosslinking the PLA.

As other glycidyl methacrylate containing solid acrylic resins used in powder coating industry, the disclosed acrylic resins to be used as chain extender for PLA preferably also contain one epoxy functional monomers such as glycidyl methacrylate or glycidyl acrylate, preferably glycidyl methacrylate. The amount of glycidyl methacrylate monomer in the total monomer composition in the present invention is preferably be 20-50 wt %, which is also an exemplary weight percentage of glycidyl methacrylate used in the powder coating industry. Or, more preferably, the resin may contain 25-45% of glycidyl methacrylate. A preferred embodiment is a chain extender acrylic resin that has epoxy equivalent weight (EEW) at range of 320 to 570.

The disclosed chain extender acrylic resin should also comprise at least one low Tg (less than −50° C.) acrylate monomer, such as butyl acrylate, 2-ethylhexyl acrylate, lauryl methacrylate, 2-butoxyethyl acrylate, hydroxypropyl acrylate, 4-hydroxybutyl acrylate, and polycaprolactone acrylate. The amount of the low Tg monomer is preferably in the range of 5-25% to allow making the epoxy functional acrylic chain extender at a Mn range higher than 6000 while having a suitable resin Melt Index (MI) of 10-60. This allows the resin to be easily handled in resin production process and have suitable resin Tg of 39-60° C. for storage stability.

The following exemplary copolymerizable ethylenically unsaturated monomers which may be suitable for use in the resin include, but are not limited to, acrylic copolymers (for example, as described in U.S. Pat. No. 4,042,645 or U.S. Pat. No. 5,270,391). For example, alkyl esters of acrylic acid or methacrylic acid, optionally together with other ethylenically unsaturated monomers. Suitable acrylic or methacrylic esters include: methyl acrylate, ethyl acrylate, propyl acrylate, n-butyl acrylate, isobutyl acrylate, tert-butyl acrylate, 2-ethylhexyl acrylate, lauryl acrylate, methyl methacrylate, ethyl methacrylate, propyl methacrylate, n-butyl methacrylate, tert-butyl methacrylate, isodecyl methacrylate, tridecyl methacrylate, lauryl methacrylate, stearyl methacrylate, 2-ethylhexyl methacrylate, and so forth and mixtures thereof. Cyclic esters such as cyclohexyl acrylate and cyclohexyl methacrylate, benzyl acrylate and/or methacrylate, as well as hydroxyalkyl esters such as 2-hydroxyethyl acrylate or methacrylate, 2-hydroxypropyl acrylate or methacrylate, and hydroxybutyl acrylate and methacrylate may also be used. In addition, vinyl monomers, vinyl aliphatic or vinyl aromatic monomers, such as acrylonitrile, methacrylonitrile, styrene, vinyl acetate, vinyl propionate, α-methylstyrene, N-vinylpyrrolidone, vinyl neodecanoate and vinyl toluene can be used. Also, acrylamides, for example, acrylamide and dimethylacrylamide; hydroxyalkyl esters of acrylic acid and methacrylic acid, for example, hydroxyethyl acrylate, hydroxypropyl acrylate, hydroxyethyl methacrylate, and hydroxypropyl methacrylate; and dialkyl esters of unsaturated dibasic acids can be used. Preferred alkyl esters of acrylic acid or methacrylic acid are methyl methacrylate and n-butyl methacrylate and especially preferred is a mixture of methyl methacrylate and n-butyl methacrylate. The ethylenically unsaturated co-monomers can further include vinyl monomers such as styrene, cc—methylstyrene, and, vinyl acetate.

The GMA acrylic resin of embodiments of the disclosure can be produced in process as well known in the industry as described in, for example, U.S. Pat. No. 7,737,238, U.S. Pat. No. 5,744,522, U.S. Pat. No. 6,479,588, U.S. Pat. No. 6,670,411, U.S. Pat. No. 5,214,101, U.S. Pat. No. 6,277,917, U.S. Pat. No. 6,552,144.

Certain embodiments of the epoxy functional solid acrylic resins presented in this disclosure provide a distinguishable faster chain extension reaction with PLA compare to conventional epoxy functional acrylic resins or other commercial PLA chain extenders currently used in industry (such as BASF's ADR 4368) as demonstrated in the chain extension examples presented in this disclosure. Preferably, the chain extension rate for a PLA application is preferably about 20% increased Mw in 60 minutes, more preferably 24% increased Mw in 60 minutes, even more preferable 26% increased Mw in 60 minutes. In another embodiment, the chain extension rate for a PLA application is preferably about 14% increased Mw in 40 minutes, more preferably 16% increased Mw in 40 minutes, even more preferable 17% increased Mw in 40 minutes. In another embodiment, the chain extension rate for a PLA application is preferably about 9% increased Mw in 20 minutes, more preferably 10% increased Mw in 20 minutes.

### EXAMPLES

### Preparation of GMA Acrylic Ctl.-1

To a two galleon Parr reactor was charged 1930 grams of xylene that was stirred at 200 rpm. Air was eliminated by consecutively pressuring and depressurizing the reactor to 60 psig with dry nitrogen four times. The mixture was heated to 139 C, after which a mixture of 450 grams of styrene, 1020 grams of methyl methacrylate, 675 grams of n-butyl methacrylate, 855 grams of glycidyl methacrylate, 3 grams of n-dodecylmercaptan and 134.1 grams of t-butylperoctoate was pumped into the reactor over 5 hours at 139 C and autogenous pressure. The charging pump and lines were rinsed with 100 grams of xylene and the polymer solution was allowed to cool to 130 C over 15 minutes. A mixture of 60 grams xylene and 15 grams t-butylperoctoate was added over two hours as the temperature fell from 130 C to 100 C. The pump and lines were rinsed with 10 grams of xylene and the polymer solution held for 30 minutes at 100 C. The product solution was cooled down to 70 C for discharging.

The product solution was then transferred to a three neck round bottom flask fitted for distillation and most of the xylene distilled at 1 atmosphere. Vacuum was then applied while bringing the temperature up to 160 C. The molten material was stirred for 45 minutes at 167-173 C and less than 4 mmHg and then poured into an aluminum pan to give a friable resin with a melt index of 50 grams per 10 minutes at 125 C under 2160 grams load, a melt viscosity of 230 poise and an epoxy equivalent weight of 520. The melt viscosity was determined in accordance with ASTM D 4287 using an ICI model VR 4752 Cone & Plate Viscometer using a 0.77 inch diameter cone operating at a shear rate of 3600 sec⁻¹. The epoxy equivalent weight was determined by the acetic acid/perchloric acid method using a Mettler Autotitrator DL25/Mettler 20 ml Buret DV920. This resin has molecular of Mw=7763, Mn=3377, PD=2.30 Measured by GPC.

### Preparation of GMA Acrylic Ctl.-2

To a two galleon Parr reactor was charged 1930 grams of xylene that was stirred at 200 rpm. Air was eliminated by consecutively pressuring and depressurizing the reactor to 60 psig with dry nitrogen four times. The mixture was heated to 139 C, after which a mixture of 900 grams of styrene, 1041 grams of methyl methacrylate, 204 grams of n-butylacrylate, 855 grams of glycidylmethacrylate, and 83.4 grams of t-butylperoctoate was pumped into the reactor over 5 hours at 139 C and autogenous pressure. The charging pump and lines were rinsed with 100 grams of xylene and the polymer solution was allowed to cool to 130 C over 15 minutes. A mixture of 60 grams xylene and 15 grams t-butylperoctoate was added over two hours as the temperature fell from 130 C to 100 C. The pump and lines were rinsed with 10 grams of xylene and the polymer solution held for 30 minutes at 100 C. The product solution was cooled down to 70 C for discharging.

The product solution was then transferred to a three neck round bottom flask fitted for distillation and most of the xylene distilled at 1 atmosphere. Vacuum was then applied while bringing the temperature up to 180 C. The molten material was stirred for 45 minutes at 175-180 C and less than 4 mmHg and then poured into an aluminum pan to give a friable resin with a melt index of 13 grams per 10 minutes at 125 C under 2160 grams load, and an epoxy equivalent weight of 520. The epoxy equivalent weight was determined by the acetic acid/perchloric acid method using a Mettler Autotitrator DL25/Mettler 20 ml Buret DV920. This resin has molecular weight of Mw=12106, Mn=4638, PD=2.61 Measured by GPC.

### Preparation of GMA Acrylic Exp. R-1

To a two galleon Parr reactor was charged 1930 grams of xylene that was stirred at 200 rpm. Air was eliminated by consecutively pressuring and depressurizing the reactor to 60 psig with dry nitrogen four times. The mixture was heated to 139 C, after which a mixture of 1770 grams of styrene, 60 grams of methyl methacrylate, 120 grams of n-butyl acrylate, 1050 grams of glycidyl methacrylate, and 90.0 grams of t-butylperoctoate was pumped into the reactor over 5 hours at 139 C and autogenous pressure. The charging pump and lines were rinsed with 100 grams of xylene and the polymer solution was allowed to cool to 130 C over 15 minutes. A mixture of 60 grams xylene and 15 grams t-butylperoctoate was added over two hours as the temperature fell from 130 C to 100 C. The pump and lines were rinsed with 10 grams of xylene and the polymer solution held for 30 minutes at 100 C. The product solution was cooled down to 70 C for discharging.

The product solution was then transferred to a three neck round bottom flask fitted for distillation and most of the xylene distilled at 1 atmosphere. Vacuum was then applied while bringing the temperature up to 180 C. The molten material was stirred for 45 minutes at 175-180 C and less than 4 mmHg and then poured into an aluminum pan to give a friable resin with a melt index of 20 grams per 10 minutes at 125 C under 2160 grams load, and an epoxy equivalent weight of 418. The epoxy equivalent weight was determined by the acetic acid/perchloric acid method using a Mettler Autotitrator DL25/Mettler 20 ml Buret DV920. This resin has molecular weight of Mw=13936; Mn=5,834, PD=2.39 measured by GPC.

### Preparation of GMA Acrylic Suitable for PLA Chain Extender Exp. R-2

To a two galleon Parr reactor was charged 1930 grams of xylene that was stirred at 200 rpm. Air was eliminated by consecutively pressuring and depressurizing the reactor to 60 psig with dry nitrogen four times. The mixture was heated to 139 C, after which a mixture of 1650 grams of styrene, 60 grams of methyl methacrylate, 240 grams of n-butyl acrylate, 1050 grams of glycidyl methacrylate, and 60.0 grams of t-butylperoctoate was pumped into the reactor over 5 hours at 139 C and autogenous pressure. The charging pump and lines were rinsed with 100 grams of xylene and the polymer solution was allowed to cool to 130 C over 15 minutes. A mixture of 60 grams xylene and 15 grams t-butylperoctoate was added over two hours as the temperature fell from 130 C to 100 C. The pump and lines were rinsed with 10 grams of xylene and the polymer solution held for 30 minutes at 100 C. The product solution was cooled down to 70 C for discharging.

The product solution was then transferred to a three neck round bottom flask fitted for distillation and most of the xylene distilled at 1 atmosphere. Vacuum was then applied while bringing the temperature up to 180 C. The molten material was stirred for 45 minutes at 175-180 C and less than 4 mmHg and then poured into an aluminum pan to give a friable resin with a melt index of 13 grams per 10 minutes at 125 C under 2160 grams load, and an epoxy equivalent weight of 418. The epoxy equivalent weight was determined by the acetic acid/perchloric acid method using a Mettler Autotitrator DL25/Mettler 20 ml Buret DV920. This resin has molecular weight of Mw=18,630, Mn=7,308, PD=2.55 measured by GPC.

### Preparation of GMA Acrylic Suitable for PLA Chain Extender Exp. R-3

To a two galleon Parr reactor was charged 1930 grams of xylene that was stirred at 200 rpm. Air was eliminated by consecutively pressuring and depressurizing the reactor to 60 psig with dry nitrogen four times. The mixture was heated to 139 C, after which a mixture of 810 grams of styrene, 660 grams of methyl methacrylate, 540 grams of polycaprolactone acrylate (SR495B from Sartomer), 990 grams of glycidyl methacrylate, and 56.4 grams of t-butylperoctoate was pumped into the reactor over 5 hours at 139 C and autogenous pressure. The charging pump and lines were rinsed with 100 grams of xylene and the polymer solution was allowed to cool to 130 C over 15 minutes. A mixture of 60 grams xylene and 15 grams t-butylperoctoate was added over two hours as the temperature fell from 130 C to 100 C. The pump and lines were rinsed with 10 grams of xylene and the polymer solution held for 30 minutes at 100 C. The product solution was cooled down to 70 C for discharging.

The product solution was then transferred to a three neck round bottom flask fitted for distillation and most of the xylene distilled at 1 atmosphere. Vacuum was then applied while bringing the temperature up to 180 C. The molten material was stirred for 45 minutes at 175-180 C and less than 4 mmHg and then poured into an aluminum pan to give a friable resin with a melt index of 34 grams per 10 minutes at 125 C under 2160 grams load, and an epoxy equivalent weight of 448. The epoxy equivalent weight was determined by the acetic acid/perchloric acid method using a Mettler Autotitrator DL25/Mettler 20 ml Buret DV920. This resin has molecular weight of Mw=21,806, Mn=6,562, PD=3.32 measured by GPC.

The following Table show the summary of the comparison of all above resin prepared:

| Resin | Ctl.-1 | Ctl.-2 | Exp. R-1 | Exp. R-2 | Exp. R-3 |
|---|---|---|---|---|---|
| Monomer | | | | | |
| Com- | | | | | |
| positions: | | | | | |
| GMA | 855 | 855 | 1050 | 1050 | 990 |
| BA | — | 204 | 120 | 240 | — |
| SR495B | — | — | — | — | 540 |
| Styrene | 450 | 900 | 1770 | 1650 | 810 |
| MMA | 1020 | 1041 | 60 | 60 | 660 |
| nBMA | 675 | — | — | — | — |
| Resin MWs | | | | | |
| Mw | 7,763 | 12,106 | 13,936 | 18,630 | 21,806 |
| Mn | 3,377 | 4,638 | 5,834 | 7,308 | 6,562 |
| PD | 2.30 | 2.61 | 2.39 | 2.55 | 3.32 |
| Resin EEQ | 536 | 527 | 418 | 418 | 448 |
| Resin MI | 50 | 14 | 20 | 13 | 34 |
| Resin Tg | 48.4° C. | 59.5° C. | 67.1° C. | 64.2° C. | 41.3° C. |

Note:
A commercial epoxy functional acrylic resins commonly used for polycondensation polymer chain extender, Johncryl ADR 4368 from BASF, has Mw = 7,432; Mn = 3,557; PD = 2.09; MI = 96; EEW = 287; Tg = 51.7 C, listed here for comparison.

### Evaluation Examples

The disclosure uses the following lab method to obtain more detail comparison of different PLA chain extender in chain extension reaction.

In 1000 L flask equipped with condenser and nitrogen purging, charge 100g of cellosolve acetate solvent, heat up to refluxing temperature at about 155 C and add 15 g of PLA 4060D, stir for 30 minutes until all PLA dissolve. Then, 0.9 g of chain extender was added into the solution. Keep the system running at refluxing condition under stirring and nitrogen purging. About 0.5CC of sample was taken out every 20 minutes for MW measurement until reach 1 hour reaction time.

The molecular weight data from above chain extension reaction of the PLA 4060D (from NatureWorks) with various GMA acrylic resins are summarized in the following Table.

| | | | | | PLA + ADR- | PLA + Exp. | PLA + Exp. | PLA + Exp. |
|---|---|---|---|---|---|---|---|---|
| | | PLA − 4060D | PLA + Ctl.-1 | PLA + Ctl.-2 | 4368 | R-1 | R-2 | R-3 |
| t = 0 | Mw | 178,907 | 161,657 | 160,288 | 157,531 | 155,900 | 155,822 | 159,340 |
| | Mn | 36,191 | 16,731 | 16,867 | 14909 | 19,217 | 23,508 | 19,324 |
| | PD | 4.94 | 9.66 | 9.5 | 10.57 | 8.11 | 6.63 | 8.25 |
| | <5000 | 1.70% | 7.40% | 5.90% | 8.90% | 5.70% | 4.00% | 5.00% |
| | Mw Change, % | 0% | 0% | 0% | 0% | 0% | 0% | 0% |
| t = 20 min. | Mw | 176,313 | 166,838 | 165,687 | 171,580 | 166,153 | 167,834 | 175,899 |
| | Mn | 35,618 | 21,477 | 25.95 | 20,502 | 25561 | 25,682 | 24,009 |
| | PD | 4.94 | 7.77 | 6.38 | 8.37 | 6.5 | 6.53 | 7.33 |
| | <5000 | 2.40% | 6.80% | 4.60% | 7.20% | 4.50% | 4.40% | 4.60% |
| | Mw Change, % | −1.45% | 3.20% | 3.37% | 8.92% | 6.58% | 7.71% | 10.39% |
| t = 40 min. | Mw | 172749 | 169,851 | 170,590 | 179,146 | 177,159 | 181,988 | 186,881 |
| | Mn | 28993 | 22,119 | 24,610 | 22,601 | 26,242 | 27,432 | 22,963 |
| | PD | 5.96 | 7.68 | 6.52 | 7.93 | 6.75 | 6.63 | 8.14 |
| | <5000 | 3.80% | 6.60% | 4.70% | 6.70% | 4.70% | 4.20% | 5.10% |
| | Mw Change, % | −3.44% | 5.07% | 6.43% | 13.72% | 13.64% | 16.79% | 17.28% |
| t = 60 min. | Mw | — | 171,958 | 176,743 | 186,111 | 185,716 | 197,375 | 197,593 |
| | Mn | — | 24,492 | 28,626 | 21,114 | 26,509 | 27,312 | 29,020 |
| | PD | — | 7.02 | 6.17 | 8.81 | 7.01 | 7.23 | 6.81 |
| | <2000 | — | 5.60% | 4.00% | 7.00% | 4.70% | 4.30% | 4.00% |
| | Mw Change, % | — | 6.37% | 10.27% | 18.14% | 19.13% | 26.67% | 24.01% |

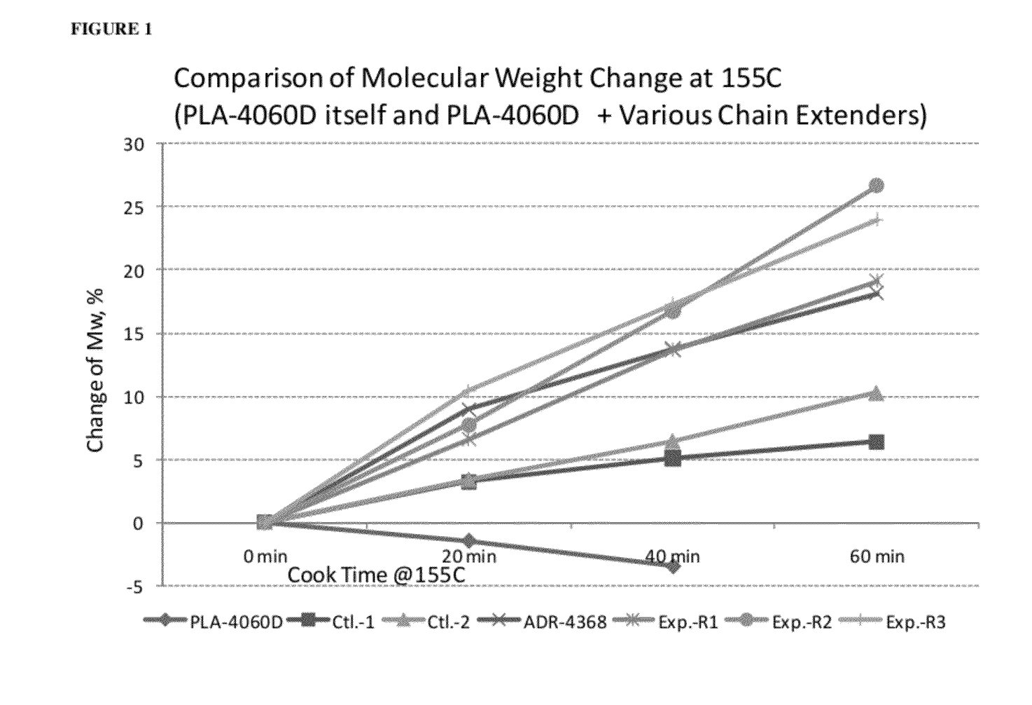

The data of PLA molecular weight (Mw) change vs. cooking time at 155° C. was also plotted in FIG. 1 for better demonstration of the performance of the claimed novel resins from present disclosure. From this figure, the PLA resin itself could thermal decompose at 155° C. Although all type of epoxy functional acrylics (Ctl.-1, Ctl.-2 and commercial Johncryl ADR 4368) can prevent PLA thermal decomposition by chain extension reaction, but the special designed resin as claimed in this invention (Exp. R-2 and Exp. R-3) can perform much better than others as shown in FIG. 1.

What is claimed is:

1. An epoxy functional acrylic resin prepared from a monomer composition comprising glycidyl methacrylate,
wherein the resin is adapted to have a chain extension capability with PLA resins at a rate of at least 20% increased Mw/hour at 155 C.

2. The epoxy functional acrylic resin according to claim 1, wherein the resin has a number average molecular weight greater than 6000.

3. The epoxy functional acrylic resin composition according to claim 1, wherein the monomer composition further comprises at least one acrylate monomer having a Tg of less than (negative)-50° C., as 5-20 wt % of the total monomer composition.

4. The epoxy functional acrylic resin composition according to claim 3, wherein the at least one acrylate monomer is selected from n-butyl acrylate or polycaprolactone acrylate.

5. The epoxy functional acrylic resin composition according to claim 1, wherein the glycidyl methacrylate is 25-45 wt % of the monomer composition.

6. The epoxy functional acrylic resin composition according to claim 5, wherein the resin has an EEW in the range of 320-570.

7. The epoxy functional acrylic resin according to claim 1, wherein the resin has a melt index at 10-60 g/10 minutes.

8. The epoxy functional acrylic resin according to claim 1, wherein the resin is adapted to be used as chain extender in PLA thermal process applications.

9. The epoxy functional acrylic resin according to claim 1, wherein the resin is in particulate form.

10. The epoxy functional acrylic resin according to claim 9, wherein the resin has a particle size distribution of:
less than 20% of the particles are 2-4 mm;
70-80% of the particles are 0.1-2 mm; and
5-15% of the particles are less than 0.1 mm.

11. An epoxy functional acrylic resin prepared from a monomer composition comprising 20-50 wt % glycidyl methacrylate, 5-25 wt % of at least one an acrylate monomer having a Tg of less than (negative)-50° C., and from 25-75 wt % of at least one ethylenically unsaturated monomer.

12. The epoxy functional acrylic resin according to claim 11, wherein the resin is adapted to have a chain extension capability with PLA resins at a rate of at least 20% increased Mw at 155 C.

13. The epoxy functional acrylic resin according to claim 11, wherein the resin has a number average molecular weight greater than 6000.

14. The epoxy functional acrylic resin composition according to claim 11, wherein the at least one acrylate monomer is selected from n-butyl acrylate or polycaprolactone acrylate.

15. The epoxy functional acrylic resin composition according to claim 11, wherein the resin has an EEW in the range of 320-570.
